(19) United States
(12) Patent Application Publication
(10) Pub. No.: US 2018/0189452 A1
(43) Pub. Date: Jul. 5, 2018

(54) SYSTEM AND METHOD FOR REMOTE HEALTHCARE

(71) Applicant: United Arab Emirates University, Al Ain (AE)

(72) Inventors: M. Adel Serhani, Al Ain (AE); Mohamed Al Hemairy, Al Ain (AE); Saad Amin, Coventry (GB); Mahmoud Alahmad, Al Ain (AE)

(21) Appl. No.: 15/395,121

(22) Filed: Dec. 30, 2016

(51) Int. Cl. G06F 19/00

(52) U.S. Cl. CPC G06F 19/345; G06Q 50/01; G06F 19/322; G06F 19/3418

(57) ABSTRACT

The disclosed embodiments include computer-implemented systems and processes that perform operations that facilitate remote healthcare in a computing environment. For example, a network-connected system may include a diagnostic module configured to receive a value for each of a plurality of physiological parameters indicating a current physiological status of a patient, and a data repository that stores diagnostic rules linking conditions related to one or more of the physiological parameters to diagnostic information. The system may also include an intervention module configured to receive indications from the diagnostic module and to output prompts to a medical expert to intervene, and a publishing module configured to receive instructions from the diagnostic module and to output advice to be displayed to the patient.

### FIELD

The present application relates to computer-implemented systems and processes that provide remote healthcare in a networked environment.

### INTRODUCTION

Today, nearly all the countries across the globe experience aging populations in need of quality healthcare. The integration of mobile technology and broadband communications, coupled with the proliferation of innovative medical devices, render possible in the development and deployment of pervasive healthcare solutions to these aging populations. These pervasive healthcare systems are often limited in their ability to interface with medical professionals (thus replacing a physical visit with a medical expert), and in their scalability and ability to support integration with other heterogeneous healthcare systems.

### SUMMARY

In one embodiment, a system for remote healthcare may include one or more modules. In one aspect, each module may be associated with a set of rules and actions to be triggered based on these rules. For example, an intervention module has pre-defined rules that if a condition is met then the corresponding action will be triggered. In this scenario, there is no intervention required from a human expert, thereby reducing the cost of the healthcare. However, if the case is not defined in the rule set (i.e. in the case of a new medical condition or situation) then review/validation is sought from the human expert.

Furthermore, in abnormal cases (such as those when the readings from the patient are extreme), emergency action is initiated. In this way, there is limited assistance required by the medical experts, while intervention is prompted when required. This ensures that the level of healthcare is not inappropriately comprised by the aim of reducing cost. This module-based architecture may be completely decentralized and innovative.

In further embodiments, a system for remote healthcare may include a diagnostic module configured to receive a value for each of a plurality of physiological parameters indicating a current physiological status of a patient; a data repository comprising a plurality of diagnostic rules, each diagnostic rule linking a condition related to one or more of the physiological parameters to information for the diagnostic module; an intervention module configured to receive indications from the diagnostic module and to output prompts to a medical expert to intervene; and a publishing module configured to receive instructions from the diagnostic module and to output advice to be displayed to the patient. When the diagnostic module determines that the received values satisfy a condition of at least one of the diagnostic rules, the diagnostic module may be configured to determine advice to be provided to the patient based on the information linked to the one or more conditions by the at least one diagnostic rule, and to send instructions to the publishing module to output the advice to be displayed to the patient. Further, when the diagnostic module determines that the received values are abnormal, the diagnostic module may be configured to output to the intervention module an indication that the received values are abnormal, and the intervention module is configured to initiate emergency action in response to the indication that the received values are abnormal. In other aspects, when the diagnostic module determines that the received values do not satisfy a condition of any of the diagnostic rules, the diagnostic module may be configured to output to the intervention module an indication that the received values do not satisfy a condition of any of the diagnostic rules together with information about the current physiological status of the patient, and the intervention module may be configured to output to the medical expert a prompt to generate advice for the patient based on the current physiological status of the patient.

In other embodiments, a method for remote healthcare includes a diagnostic module receiving a value for each of a plurality of physiological parameters indicating a current physiological status of a patient; a data repository storing a plurality of diagnostic rules, each diagnostic rule linking a condition related to one or more of the physiological parameters to information for the diagnostic module; an intervention module receiving indications from the diagnostic module and outputting prompts to a medical expert to intervene; and a publishing module receiving instructions from the diagnostic module and outputting advice to be displayed to the patient. When the diagnostic module determines that the received values satisfy a condition of at least one of the diagnostic rules, the diagnostic module may determine advice to be provided to the patient based on the information linked to the one or more conditions by the at least one diagnostic rule, and sends instructions to the publishing module to output the advice to be displayed to the patient. Further, when the diagnostic module determines that the received values are abnormal, the diagnostic module may output to the intervention module an indication that the received values are abnormal, and the intervention module initiates emergency action in response to the indication that the received values are abnormal. In other aspects, when the diagnostic module determines that the received values do not satisfy a condition of any of the diagnostic rules, the diagnostic module may output to the intervention module an indication that the received values do not satisfy a condition of any of the diagnostic rules together with information about the current physiological status of the patient, and the intervention module may output to the medical expert a prompt to generate advice for the patient based on the current physiological status of the patient.

Additionally, in some embodiments, a system may include a a storage device and at least one processor coupled to the storage device. The storage device may store software instructions for controlling the at least one processor when executed by the at least one processor, and the at least one processor is operative with the software instructions and is configured to receive values of physiological parameters indicating a current physiological status of a patient, and access a data repository comprising a plurality of diagnostic rules. The diagnostic rules may link conditions related to the physiological parameters to diagnostic information. The at least one processor may also be configured to determine whether the received values satisfy the condition related to at least one of the diagnostic rules, and when the received values are determined to satisfy the at least one condition, generate advice data based on the diagnostic information linked to the condition by the at least one diagnostic rule, and to present the generated advice data to the patient through a corresponding interface. The at least one processor may also be configured to determine whether the received values represent abnormal values, and when the received values are determined to represent the abnormal values, provide, to an intervention module, first output data comprising an indication that the received values are abnormal. The intervention module may be configured to initiate an emergency action in response to the indication that the received values are abnormal. The at least one processor may also be configured to determine whether the received values fail to satisfy the conditions of the diagnostic rules, and when the received data fails to satisfy the conditions, provide, to the intervention module, second output data comprising an indication that the received values fail to satisfy the conditions of the diagnostic rules and information characterizing the current physiological status of the patient. In one aspect, the intervention module may be configured to present data prompting the medical expert to provide advice to the patient based on the current physiological status of the patient.

The disclosed embodiments also include a computer-implemented method that includes receiving, by at least one processor, values of physiological parameters indicating a current physiological status of a patient, and accessing, by the at least one processor, a data repository comprising a plurality of diagnostic rules. The diagnostic rules may link conditions related to the physiological parameters to diagnostic information. The method also includes determining, by the at least one processor, whether the received values satisfy the condition related to at least one of the diagnostic rules, and when the received values are determined to satisfy the at least one condition, generating, by the at least one processor, advice data based on the diagnostic information linked to the condition by the at least one diagnostic rule, and presenting, by the at least one processor, the generated advice data to the patient through a corresponding interface. The method also determines, by the at least one processor, whether the received values represent abnormal values, and when the received values are determined to represent the abnormal values, provides, by the at least one processor, and to an intervention module, first output data comprising an indication that the received values are abnormal. The intervention module may be configured to initiate an emergency action in response to the indication that the received values are abnormal. The method also includes determining, by the at least one processor, whether the received values fail to satisfy the conditions of the diagnostic rules, and when the received data fails to satisfy the conditions, provide, by the at least one processor, and to the intervention module, second output data comprising an indication that the received values fail to satisfy the conditions of the diagnostic rules and information characterizing the current physiological status of the patient. In one aspect, the intervention module may be configured to present data prompting the medical expert to provide advice to the patient based on the current physiological status of the patient.

The disclosed embodiments may also include a tangible, non-transitory computer program product that stores machine-readable instructions which, when executed by one or more processors, cause the one or more processors to perform any of the computer-implemented methods described herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a system for remote health monitoring in a smart-home according to an embodiment of the present invention.

FIG. 2 shows a detailed view of the social network analysis module according to an embodiment.

FIG. 3 shows an example of a disease search algorithm that is used according to an embodiment.

FIG. 4 shows a sample set of diagnostic rules according to an embodiment.

FIG. 5 shows an example screenshot of the medical record of a patient as viewed by the medical expert (i.e. the attendant physician) according to an embodiment.

FIG. 6 shows an example screenshot of the blood glucose record of a patient as viewed by the medical expert (i.e. the attendant physician) according to an embodiment.

FIG. 7 shows an example screenshot of the blood pressure record of a patient as viewed by the medical expert (i.e. the attendant physician) according to an embodiment.

FIG. 8 shows an example screenshot of the patient interface as viewed by the patient according to an embodiment.

FIG. 9 shows an example screenshot of the blood pressure record of a patient as viewed by the patient according to an embodiment.

FIG. 10 shows an example screenshot of the blood sugar record of a patient as viewed by the medical expert (e.g., the attendant physician) according to an embodiment.

FIG. 11 shows an example screenshot of the cholesterol record of a patient as viewed by the medical expert (e.g., the attendant physician) according to an embodiment.

FIG. 12 shows an example screenshot of the heart rate record of a patient as viewed by the medical expert (e.g., the attendant physician) according to an embodiment.

FIGS. 13-16 depict images of graphical user interfaces presented to medical staff by mobile or web applications executed on corresponding mobile devices (e.g., medical staff web application views), according to an embodiment.

FIGS. 17-20 depict images of graphical user interfaces presented to a patient by mobile or web applications executed on corresponding mobile devices (e.g., patient mobile views), according to an embodiment.

FIGS. 21-23 depict images of graphical user interfaces presented to a physician by mobile or web applications executed on corresponding mobile devices (e.g., physician mobile views), according to an embodiment.

### DETAILED DESCRIPTION

I. Exemplary Systems and Processes for Remote Healthcare

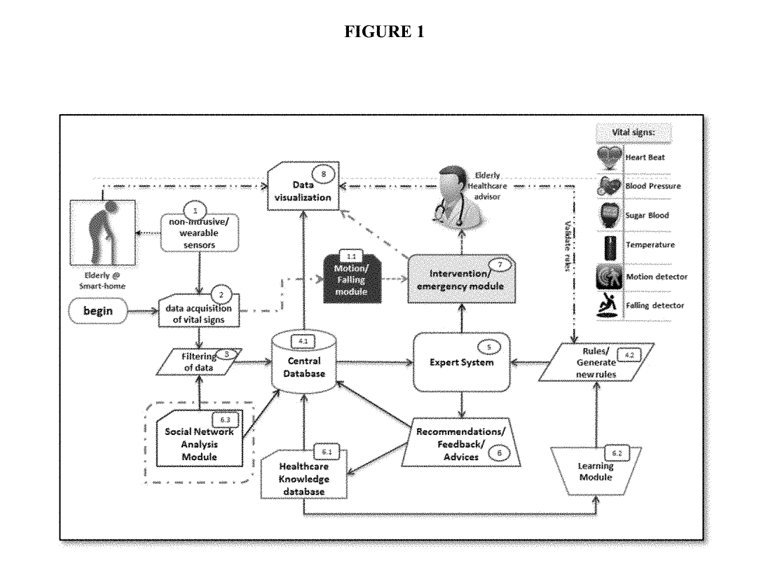

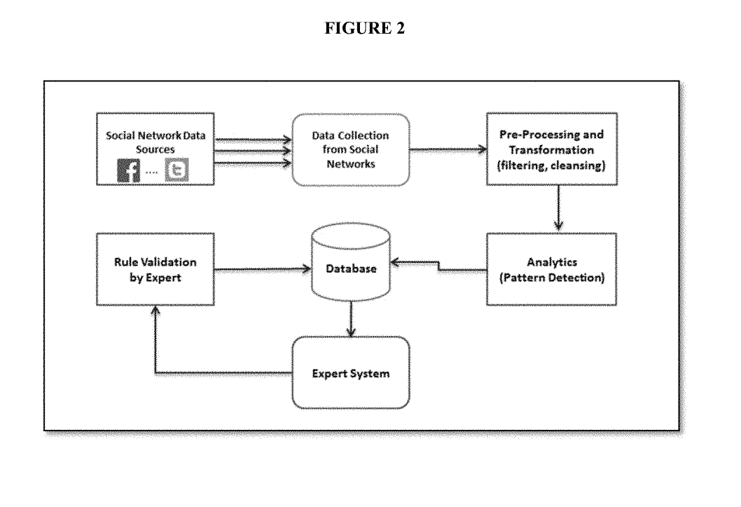

FIG. 1 schematically depicts a system for remote healthcare, in accordance with certain disclosed embodiments. Optionally, the system comprises a diagnostic module 5 configured to receive a value for each of a plurality of physiological parameters indicating a current physiological status of a patient.

In an embodiment, the system for remote healthcare may be implemented through an architecture of smart health monitoring system. Optionally, the system comprises a user interface, some clinical devices, a transmission medium (e.g., a wireless or wired communications network) and supporting software and hardware (e.g., a display module, such as a LCD screen or CRT monitor, an input module, such as a keyboard, mouse, or pressure-sensitive touchscreen display, and one or more processors coupled to one or more tangible, non-transitory storage devices or memories). The healthcare technology user interface can be achieved through a healthcare technology workstation. The healthcare technology workstation may be a personal computer (PC) or a personal digital assistant (PDA) or a mobile device having one or more processors and one or tangible, non-transitory memories. The user can interface for instance through a telephone pad, mouse, touch screen, remote control, joystick, and voice recognition system. Clinical devices (e.g., one or more sensors and sensor devices) are connected to the healthcare technology workstation for local healthcare providers to capture patient vital signs or other clinical data, such as images and sounds. In one aspect, the clinical devices may be connected to the healthcare technology workstation through one or more wired or wireless communications networks, and may exchange data using any of a number of appropriate communications protocols, such as hypertext transmission protocol (HTTP), internet protocol, Bluetooth communications protocols, or near-field communication (NFC) protocols.

In other aspects, the patients to expressly engage with any medical devices. This abstraction may, for example, be achieved through embedding sensors such as in mattresses, toilets, kitchen appliances and clothing. Such embedded sensors can sense sleep pattern, body weight, body temperature, pulse rate and so forth.

Currently, researchers are conducting experiments on advanced tele-sensing modalities that employ the Doppler radar technique to gather scattered vital signs from throughout the body. These systems can gather multiple clinical parameters and are able to operate autonomously without disturbing the lives of the patients. Various integral components of remote health monitoring system include a widely deployed wireless network and advanced computing technologies. Various monitoring systems have been proposed for monitoring different clinical parameters, such as electrocardiogram (ECG) data, blood glucose levels, Blood Pressure and Body Temperature.

Examples of application-based ECG monitoring systems include, but are not limited to, CardioNet's MCOT™, LifeSync's Wireless ECG System, AUBADE, ICER system and Pinmed's Pelex-04. Among these, CardioNet's MCOT™ has the ability to enable the physician to be alerted and take action promptly when required. While most of these require the sensors to be disposed on patient's body and involves connections to a device using leads, LifeSync's Wireless ECG System is unique and has the edge for being able to acquire and transmit data wirelessly. AUBADE does propose a basic framework for communication of clinical data over a network however does not provide abilities for full-scale integration between different stakeholders involved in healthcare. Examples of sensor-based ECG monitoring systems include, among others, Toumaz's Sensium™ Life Platform TZ2050 and Shimmer's Wireless ECG Sensor. Soteras Wireless ViSi Mobile™ System provides a mobile based ECG monitoring system.

Examples of monitoring systems for other clinical parameters, such as blood pressure and blood glucose levels, include Entra Health Systems' MyGlucoHealth, vitalo Ltd's SmartLAB® Global Glucose Monitor—D10419-SmartLAB Global, and FORA's D15b BG plus BP Monitor (Bluetooth Version). Further, examples of mobile, sensor-based Blood Glucose monitoring systems include AT&T's Diabetes Manager®, Agamatrix's iBGStar Blood Glucose Monitoring System, and LG's KP8400 Cell phone with blood glucose monitor. Similar specific monitoring systems can be used for monitoring blood pressure and body temperature, among others.

Examples of systems capable of monitoring multiple clinical parameters include, among others, A&D's CP-1 THW Complete Wireless Software Connected Health Monitoring System, CareMatrix's CareMatrix Wellness System (CWS), HoneyWell's HomMed Genesis™ DM Remote Patient Care Monitor, Bosch Healthcare's Health Buddy System, and Viterion's Viterion 100 Health Monitor & Viterion 200 TeleHealth Monitor.

Healthcare generates a huge amount of data resulting from executing different types of operations, including monitoring and gathering health related data. Health data processing and analytics, and their interpretation reveal patterns and trends, which are crucial for health professionals. These processes often require high performance data centers, powerful servers and advanced data analytics tools, such as NoSQL and Hadoop platforms. Therefore, in certain embodiments, the system described below may, among other things, leverage evolving Cloud infrastructure, platforms, and services to guarantee high performance, scalable and reliable healthcare services without the need for these high performance data centers and powerful servers.

Since healthcare relies on mobile devices to provide services to mobile patients, these devices are susceptible to rapid power drainage. This is a real challenge since this will induce disruption of services if the device's battery is fully drained. However, in an urgent situation, crucial health data should be communicated to physicians or emergency caregivers, which might have severe consequences if not timely communicated. Therefore, in one embodiment, the disclosed system intelligent algorithms to reduce processing tasks at the mobile device and to delegate some processing to a backend infrastructure, in addition to disabling all processes running on the background and are not needed.

In other embodiments, the disclosed systems and processes provide an integrated and scalable framework for remote health monitoring. The healthcare monitoring system may be for the aged-care at home with around the clock health monitoring in a non-intrusive manner. It helps the elderly to survive independently at their homes by assisting them in their regular day-to-day activities and their Activities of Daily Living (ADL) to make their life easier, more entertaining and pleasant through consistent interactions across services.

These systems and processes, as described below, may integrate smart technologies to establish an infrastructure that monitors the vital signs of the patient at home around the clock. These systems and processes may provide the elderly (or other patients) with instantaneous feedback based on their current medical conditions as well as communicates with their physicians for advices or calls in emergency at contingency situations. In an embodiment, the system comprises sensors and actuators to provide continuous health monitoring for the elderly and helps them to carry out their daily routines individually. Further, the system may also measure the ability of normal activities of aged-care and how active or normal an elderly person, and improve the lives of the elderly while they are at home.

The system framework shown schematically in FIG. 1 involves the monitoring of different clinical parameters for the elderly. In one aspect, the disclosed system and corresponding framework involves data acquisition, processing and analysis of the acquired data using an artificial intelligence based diagnostic engine. Optionally, the disclosed systems and processes render the most appropriate recommendations to the concerned users for presentation through a corresponding interface, such as a visual display, screen, and voice command. While the framework exploits artificial intelligence to automate processing of large volumes of inflowing data, it also provides the flexibility of manual intervention. A medical expert may initiate manual intervention on his accord or in response to being prompted by the system for doing so.

The patient's vital signs may be captured by various non-intrusive and wearable sensors and are sent to a data acquisition module (e.g., a module of code executed by at least one processor of the system, or code executed by at least one processor of a hardware-based data acquisition module). The data may then be filtered from noise and invalid values and stored in a central database, e.g., within a tangible, non-transitory storage medium. Various data will also be obtained from other sources such as a knowledge database and at least one social network. If there is an emergency case, such as a fall, an intervention module will be triggered immediately. In one aspect, the intervention module may correspond to elements of code executed by at least one processor of the system, and additionally or alternatively, by at least one processor of a device associated with a medical expert, which may be connected to the system across a communications network. In other aspects, the intervention module may correspond to an element of hardware including one or more processor and corresponding tangible, non-transitory memories, which may form a portion of the disclosed systems or a portion of other systems in communication with the disclosed systems.

In one aspect, the disclosed systems and processes may examine the obtained data from the patient and checks the predefined rules for matching cases, and will take the appropriate action accordingly. The action will be in a form of advice, recommendations, or generating new rules (e.g., in case the condition of the patient was not defined in the knowledge base) through the leaning module. In an embodiment, to ensure rule validation and system accuracy, no new rules are added without human expert validation. The system may display the information to both the patient and the physician simultaneously, such as warning, alarms or medical advice, through interfaces of corresponding display module.

The main modules of our proposed framework are described in further detail below. In some embodiments, one or more of these modules may correspond to elements of code executed by at least one processor of the system, and additionally or alternatively, by at least one processor of other devices or computing systems connected to the system across a wired or wireless communications network. In other aspects, one or more of these modules may include hardware-based modules having corresponding processors and tangible, non-transitory memories storing instructions or code executable by the processors to perform the operations described herein. By way of example, the one or more hardware-based modules may be incorporated into and form a part of the system described below, or may form a portion of other systems connected to the system over wired or wireless communication.

Optionally, the system may include a data acquisition module 2 for the data acquisition of vital signs. Optionally, the data acquisition module 2 may include a plurality of sensors 1, each sensor 1 configured to acquire a value for at least one of the physiological parameters for the patient. Each sensor 1 may be non-intrusive and wearable. The data acquisition module 1 may be configured to output the acquired values for the diagnostic module (otherwise known as an expert system) 5.

Optionally, the data acquisition module 1 may include a network of sensors 2 for acquiring clinical data of monitored subjects in their homes. Various examples of clinical data acquired through the data acquisition module 1 include, but are not limited to, heart beat rate, blood pressure, sugar blood, temperature, and data indicative of motion and falls.

Optionally, the system may include a data filtering module 3. The data filtering module 3 may be configured to filter the acquired data to eliminate noise, errors or invalid values using different filtering techniques/algorithms including low-pass filters, high-pass filters, and noise removal/cancellation which can be used to pre-process sensor data before processing.

Optionally, the system may include a data repository 4.2 comprising a plurality of diagnostic rules. Each diagnostic rule may link a condition related to one or more of the physiological parameters to information for the diagnostic module 5. Further, in some aspects, the system may include one or more tangible, non-transitory memories or storage devices having corresponding structured data records, portions of which may establish data repository 4.2. In other aspects, data repository 4.2 may be established and maintained by one or more additional computing systems or remote repositories (e.g., cloud-based storage) accessible to the system across corresponding wired or wireless communications networks.

As mentioned above, the system may include a diagnostic module 5 configured to receive a value for each of a plurality of physiological parameters indicating a current physiological status of a patient. In one aspect, the diagnostic module 5 is implemented to effectively substitute a human medical expert. The diagnostic module 5 may be interfaced with the data repository 4.2 containing for instance, a set of rules related to diagnostics, alert generation and prompting manual intervention. A Bayesian network may, for instance, be used for data classification. In other aspects, the disclosed embodiments include algorithms facilitating real-time diagnosis of medical conditions (e.g., diseases) based on derived mathematical expressions, as described below.

The system may also include a publishing module configured to receive instructions from the diagnostic module 6 and to output advice to be displayed to the patient, e.g., through an interface via the display unit. The publishing module 6 may, in some instances, interface with the diagnostic module 5 and publishes advice and/or recommendations to suitable target devices (monitored subject, responsible healthcare professional, or both).

The system may further include an intervention module 7 configured to receive indications from the diagnostic module 5 and to output prompts to a medical expert to intervene.

In an embodiment, the intervention module 7 may perform operations associated with urgent and emergency cases where the captured signs were identified by the diagnostic module 5 as extremely abnormal. The intervention module 7 may, in some aspects, generate, and present an urgent warning to the responsible healthcare professionals (or alternatively, transmit data indicative of the urgent warning to devices of these responsible healthcare professionals), as well as trigger a performance of other actions or operations, such as triggering a request for dispatching ambulance to the subject's location by transmitting data to a computer system or executable application program associated with a corresponding ambulance service (e.g., across a wireless network or through a corresponding programmatic interface). Additionally, the intervention module 7 may perform operations that allow the medical staff to review and validate or update the final advice for the patient, e.g., based on data presented through an interface via a display module (such as display module 8 of FIG. 1) or transmitted to one or more devices of the medical staff.

As described herein, a framework consistent with the disclosed embodiments may include a set of software-based or hardware-based modules. In one aspects, each of the modules may store data (e.g., in a tangible, non-transitory memory) establishing a set of rules and actions to be triggered based on these rules. For example, the intervention module 7 may store, in memory, data establishing a pre-defined diagnostic rule that if a particular condition happens to occur, then corresponding action will be triggered (e.g., an execution of code by a processor that causes a performance of a particular operation). In some aspects, no intervention or recommendation required from a human expert prior to the triggered action.

For example, when the diagnostic module 5 determines that the received values satisfy a condition of at least one of the diagnostic rules, the diagnostic module 5 is configured to determine advice to be provided to the patient based on the information linked to the one or more conditions by the at least one diagnostic rule, and to send instructions to the publishing module 6 to output the advice to be displayed to the patient, e.g., through the display module.

Furthermore, in some instances, when the diagnostic module 5 determines that the received values are abnormal, the diagnostic module 5 is configured to output to the intervention module 7 an indication that the received values are abnormal, and the intervention module 7 is configured to perform operations that initiate emergency action in response to the indication that the received values are abnormal.

The diagnostic module 5 may also be configured to determine that the received values are abnormal based on the information linked to the one or more conditions by the at least one diagnostic rule. In an alternative embodiment, the diagnostic module 5 may be configured to determine that the received values are abnormal without reference to the at least one diagnostic rule.

In further aspects, if the condition of the patient is not defined in the rule set (e.g., if it is a new medical condition or situation) then the learning module 6.2 may become active, and prompt the human expert to the review and/or validate the suggested action (e.g., based on data presented through an interface via the display module) and to provide input to the diagnostic module 5 indicative of the review and validation (e.g., through an input module, such as a keyboard, pressure-sensitive touchscreen display, mouse, microphone, etc.). In this way, there is limited assistance of the medical experts (and/or the human support) which may represent a goal of the framework for remote healthcare monitoring.

In some embodiments, when the diagnostic module 5 determines that the received values do not satisfy a condition of any of the diagnostic rules, the diagnostic module 5 is configured to provide, to the intervention module 7, output data including an indication that the received values do not satisfy a condition of any of the diagnostic rules and information about the current physiological status of the patient. The intervention module 7 may, in certain instances, be configured to present portions of the output data to the medical expert as a prompt to generate advice for the patient based on the current physiological status of the patient (e.g., through an interface via the display module). In other instances, the intervention module 7 may be configured to transmit portions of the outcome data to one or more devices of the medical expert, which may be connected to the system across one or more wired or wireless communications networks.

In additional aspects, the diagnostic module 5 and/or the intervention module 7 may be configured to provide the medical expert with a proposed set of information and advice to be displayed to the patient through an interface via the display module 8 (and additionally or alternatively to transmit data that includes the proposed set of information and advice to a device of the medical expert, as described above). The medical expert can then modify or approve the information and advice. Once the medical expert has modified or approved the advice, the medical expert may provide data indicative of the modification or approval to the learning module 6.2 through a corresponding input module, such as the keyboard, pressure-sensitive touchscreen display, mouse, or microphone described above. The learning module 6.2 may, in some aspects, implement one or more machine-learning algorithms to “learn” from the experience to modify an existing diagnostic rule or create a new diagnostic rule based on the feedback from the medical expert. The learning module 6.2 may store the updated or new diagnostic rule in the data repository 4.2.

In order for the medical expert to determine appropriate information and advice to be shown to the patient, the disclosed systems and processes may provide the medical expert with information about the current physiological status of the patient. For example, the diagnostic module 5 and/or the intervention module 7 may present the medical expert with the acquired values of the parameters and/or information about the status of the patient from the diagnostic rules (e.g., through the interface of the display module), and additionally or alternatively, may transmit data indicative of the acquired values and/or information to a device of the medical expert.

In other aspects, may not be necessary for the diagnostic module 5 or intervention module 7 to provide the medical expert with a proposal of information and advice to be displayed to the patient. In additional instances, the system may present data through the display module 8 that prompts the medical expert to provide input, e.g., through the input module.

The system may, in additional embodiments, include a learning module 6.2 configured to receive the advice generated by the medical expert (e.g., as provided to the input module), and perform operations that generate a new diagnostic module linking a condition related to the current physiological status of the patient to the advice generated by the medical expert.

The learning module 6.2 may be configured to update the data repository 4.2 with new rules whenever required. As described above, the learning module 6.2 may implement one or more machine-learning algorithms to “learn” from the new recommendations/feedback provided by the medical expert and the previous experiences. Based on an outcome of the implemented machine-learning algorithms may derive one or more new diagnostic rules and update one or more existing diagnostic rules.

In some aspects, the learning module 6.2 may continuously improve the knowledge base captured using data classification techniques, such as Bayesian classifiers, to generate accurate and valid medical advice, and therefore, result in the best possible decision.

As described above, the system may include a display module, such as the display module 8 of FIG. 1, which may include a LCD screen or a CRT monitor. In some aspects, display module 8 may be configured to display advice received from the publishing module 6 and from the medical expert.

The display module 8 may also receive, and render for presentation, the recommendation/advice generated by the diagnostic module 5 or provided by the medical expert through the intervention module 7 for both the elderly patient and the healthcare staff.

In additional aspects, the system may include a fall detection module 1.1 configured to detect when the patient falls, and to output directly to the intervention module 7 an indication that the patient has fallen. As described above, the intervention module 7 may be configured to initiate a performance of one or more emergency actions in response to the indication that the patient has fallen.

The fall detection module 1.1 may be configured to perform operations associated with emergency situations, such as detecting fall incidents and other e that require an immediate attention and high processing. The fall detection module 1.1 may be mapped directly to the intervention module 7 such that a performance of an emergency action is taken immediately, such as operations that request an ambulance and alert the responsible healthcare professional, as described above.

In one aspect, the emergency action may include sending an urgent warning to a device associated with the medical expert or presenting the urgent warning through display module 8. The emergency action may also include, but is not limited to, triggering a request for dispatching an ambulance to the patient, such as by transmitting a request to a computer system associated with an ambulance service.

As described above, system may also include a social network analysis module 6.3 configured to collect health data of the patient from at least one social network (e.g., from a computer system maintained by that and to send to the diagnostic module 5 a value for at least one physiological parameter based on the health data.

In some aspects, the social network analysis module 6.3 may obtain data from computer systems of the social networks, filters the obtained data, and analyze the filtered data to extract insights relevant to the monitored physiological state. Additionally, the outcome of the analysed data may also enrich the knowledge base with new knowledge and possibly derive new rules.

Some other components are supportive components that complement the roles of the above modules.

For example, the system may include a central database 4.1 (e.g., as established within one or more tangible, non-transitory memories). The central database 4.1 may store medical data from various sources, which encompasses data from the sensors 1, the knowledge database module 6.1, the publishing module 8, and external databases such as social networks.

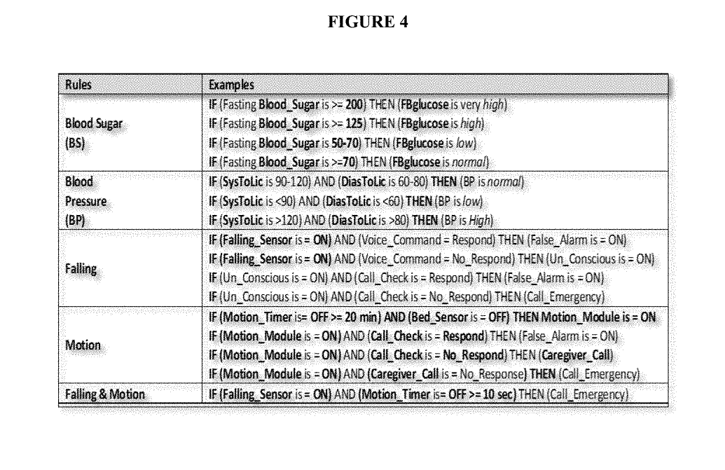

The system may also include comprises a knowledge database module 6.1. The knowledge database module 6.1 may include data from various sources, such as data acquired from the sensors 1, the patient's medical history information, and knowledge from other external databases, e.g., data collected from social networks, as described below. In one aspect, the social network analysis module 6.3 may be configured to obtain heath related data from computing systems maintained by one or more social networks, implementing pre-processing and transformation activities (e.g. filtering, restructuration, etc.) on the obtained data to derive relevant health-related information and augmenting the central database 4.1. Further, in additional aspects, the system may apply data analytics to portions of the stored data to detect patterns, validate rules, and additionally or alternatively, deduce new rules. FIG. 4 describes the components of the social network analysis module 6.3 and the sequence of interactions among them.

As illustrated in FIG. 4, raw data may be collected from the computer systems maintained by the social networks (e.g. Facebook™ and Twitter™). The data may be filtered to remove the unwanted or invalid data (or information) and maintain only the relevant, structured health-related data in specific format (i.e. XML, ERD). In some aspects, system 140 may apply data analytics or machine-learning algorithms to the filtered health-related data to derive patterns and new rules. The filtered health-related data is stored in the central database 4.1.

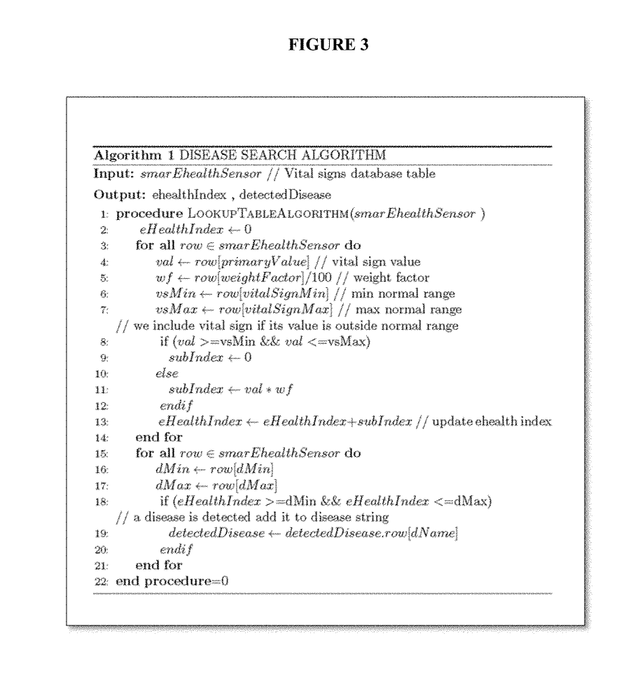

Self-diagnosis of diseases may, in some instances, allows for early disease detection and for an appropriate and prompt treatment. Furthermore, due to the increasing spread of diseases and their corresponding symptoms nowadays, it becomes impossible for a physician to recall all symptoms and medical conditions for all kind of diseases. FIG. 3 includes pseudocode illustrating an algorithm that, when implemented by a web-based platform supporting a medical expert system (e.g., the diagnostic module 5) enables the web-based platform to diagnose diseases based on the vital sign values acquired from the wearable sensors 1 on a real-time basis. As illustrated in FIG. 3, the algorithm uses a single and a unique indicator value to search in a look up table for the predefined corresponding disease. The use of the single indicator value reduces the computational time and energy required by the system to diagnose a disease, when measured relative to alternative systems that incorporate inference rules methods for disease diagnosis.

A sample set of diagnostic rules that may be configured in the data repository 4.2 is provided in FIG. 4.

In some aspects, systems consistent with the disclosed embodiments may include an application server. The system may, for example, be hosted on a Glass Fish application server and RabbitMQ servers running on a Linux platform in a cloud environment and connecting to MySQL Database servers, and may incorporate technologies such as JSP, Servlet, EJB, MDB, and JDBC. Communications between various hardware-based components of the system may occur across a wires or wired communications network, and may proceed in accordance with various communications protocols, such as HTTP, secure HTTP (HTTPS), TCP/IP communication protocols, and other communications protocols or standards.

The system may also include a client device, such as a tablet computer, smart phone, or desktop or laptop computer. Users are able to access the system through a mobile application executed by the client devices, as well as via web application browsers executed by the client devices. HTML5 may, in some aspects, be used to support interoperability across mobile applications and provide high flexibility and dynamic features.

In some aspects, access rights are granted to any user accessing the application-landing page. Only an administrator user can add or remove other creators and perform other administrative tasks.

In additional aspects, a relational database is used for data persistence. Data management rules may be enforced to ensure consistency and accuracy of data.

The disclosed embodiments impose no particular constraint related to system performance. The system may respond to any request under standard database and web server script timeouts. Also, system performance may depend on available hardware, network and Internet connection capabilities.

Merely as a specific example, the monitoring system may be implemented using one or more applications executed on one or more devices and systems operating within a networked computing environment. In some aspects, the executed applications may be stored by within tangible, non-transitory memories incorporated into these devices and systems, and may include, but are not limited to, mobile applications and web applications that leverage the components of, and implement certain processes associated with, the monitoring system described above (e.g., Data Acquisition, Data Processing, Data Analysis, Data Visualization, etc.). In one instance, the data acquisition module may collect data from one or more sensors via Bluetooth communications, transmit the collected data to a tablet or mobile application via Wi-Fi communications (e.g., using a programmatic interface, etc.), which may store the collected sensor data in structured data repository, e.g., a MySQL database. By way of example, the sensor monitoring heartrate may include a Zephyr HxM sensor, while the sensors monitoring blood pressure and blood glucose may include MyTech and iBGStar sensors respectively. The diagnostic engine may, in some instances, test the collected sensor data against pre-defined rules and conditions, and generate advice or recommendations, and additionally or alternatively, triggers other actions, such as those described above in conjunction with the emergency and intervention modules, the data visualization modules (e.g., as charts, medical advices, warnings to the system users, such as patients, physicians, and system or device administrators). Other pieces of hardware and software may, however, be used to implement others of the disclosed embodiments.

Table 1 provides a brief description of technologies and devices of one of the disclosed exemplary embodiments.

TABLE 1

| System | Description & Use | Examples |
|---|---|---|
| Database | Servers used to store data | MySQL |
| Server | acquired by sensors, generated | Oracle |
| | rules, medical advices & | |
| | recommendations. | |
| Visualiza- | Display information to patient | Tablet, Smart phones |
| tion Devices | & physician based on user | LCD, Dashboard, |
| | role (Sys Admin, physicians, | Printout |
| | elderly, nutritionist, etc. | |
| Processing/ | Hosted locally (or as | iCloud servers (hosting |
| Application | webserver) to process | the expert system, |
| Servers | data, analyze conditions | process recommendations |
| | using expert system. | & learning module. |
| Sensor | Set of sensors to capture | Zephyr HxM (heartrate) |
| Devices | different parameters from | for Android & iPhone |
| | patient at home, i.e. | MyTech (Blood Pressure) |
| | wearable sensors. | iBGStar (Blood Glucose) |
| Diagnostic | Expert System consists of set | Expert system is developed |
| Engine | of rules and conditions based | using Java-based engine. |
| | on medical case. Then it | |
| | processes the rules & generate | |
| | advices or trigger Intervention | |
| | Emergency module if needed. | |

As mentioned previously, the healthcare monitoring system after collecting the data from various sources (e.g., sensors, knowledgebase, social networks, etc.) will be checked against the set of rules stored in the system database. If the captured sensor value is within the abnormal range of a specific medical condition, then a matching case will be found and a set of actions (e.g., recommendations) will be generated and displayed to the patients and/or the medical staff In certain aspects, these rules may be set and validated by the medical human expert in advance.

In further aspects, a mobile application may be implemented on an Android platform and may be deployed on different mobile devices including a smartphone and a tablet.

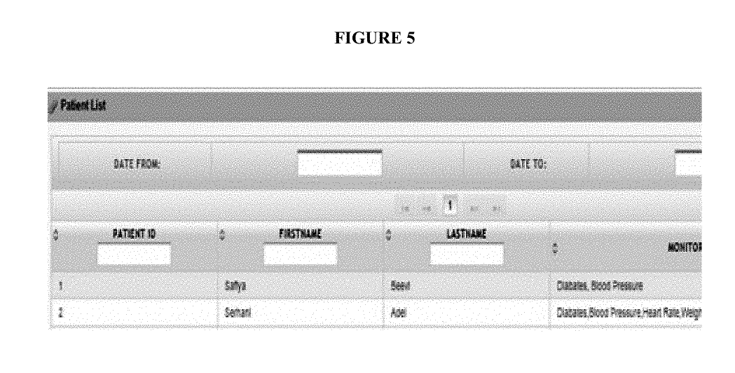

FIGS. 5 to 12 depict different views of the monitoring system including a medical staff view, a patient view, the web application views and the mobile application views.

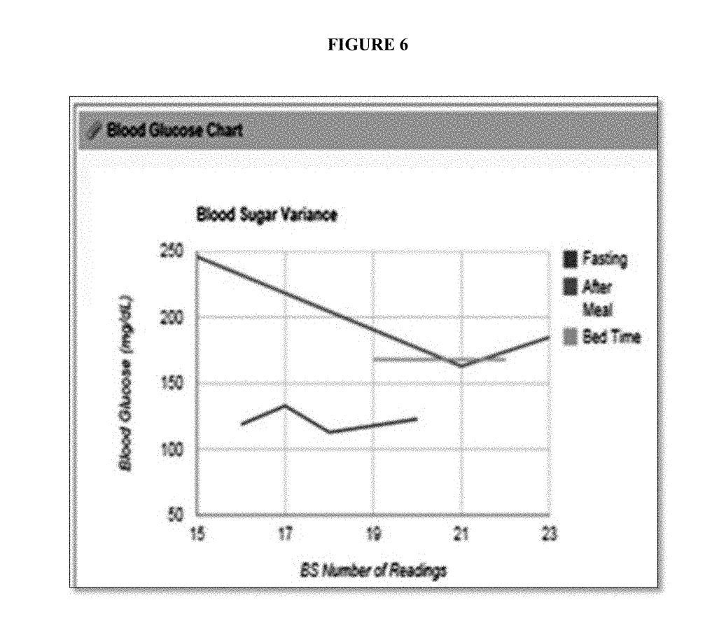

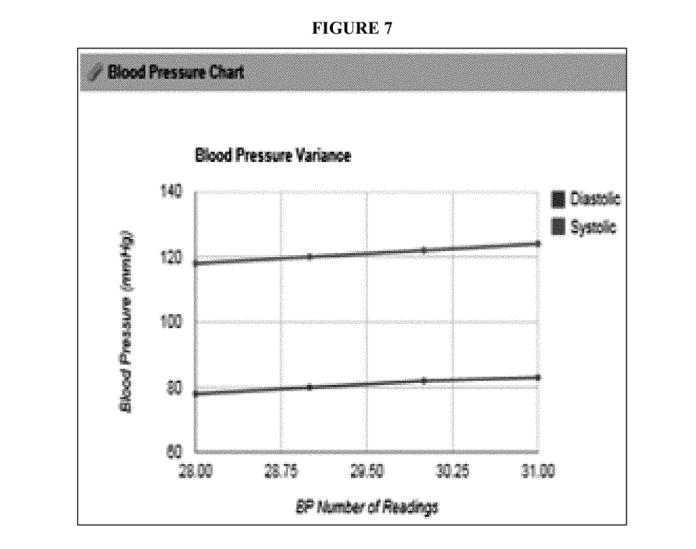

FIGS. 5 to 7 show the medical staff web application view. In particular, FIG. 5 shows the patient medical records for the attendant physician to monitor their health conditions in real-time and get prompt medical assistant if necessary. FIGS. 6 and 7 are examples of how the captured data by the system is processed and analyzed simultaneously to provide the medical staff up-to-date data besides the history of patient's records in order to provide the best medical advice. FIG. 6 is a blood glucose monitoring screen. FIG. 7 is a blood pressure monitoring screen.

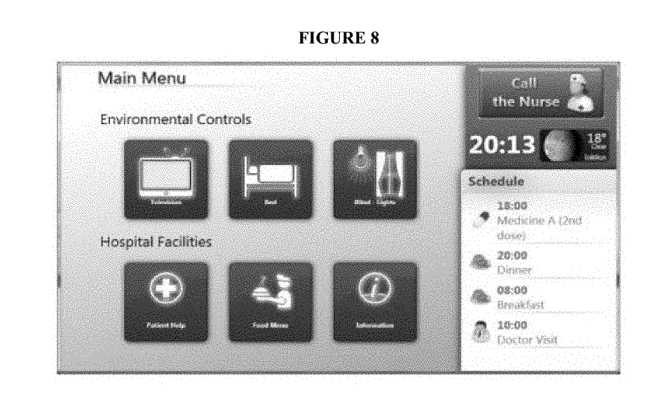

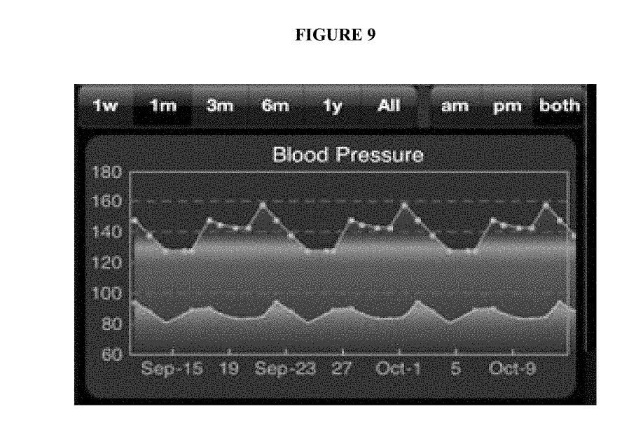

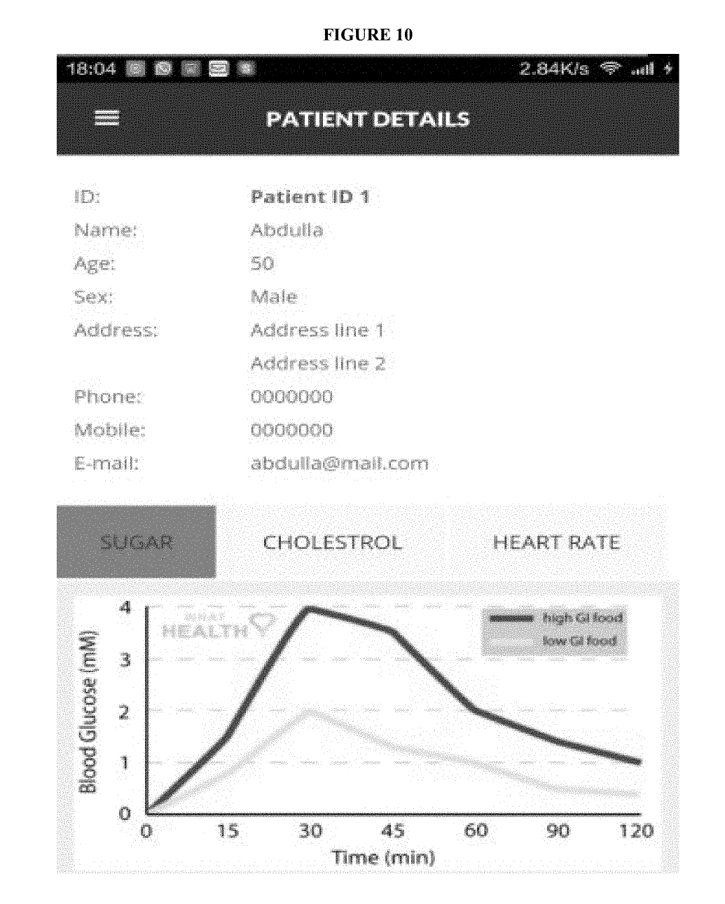

FIGS. 8 to 9 show the patient mobile view. Simple and clear messages are shown to the patient, e.g. health and nutrition advice, and/or alerts on their current medical status (e.g. blood rate, and blood pressure). FIGS. 9 and 10 are examples of how the data captured by the system is processed and analyzed simultaneously to provide an up-to-date medical status for the patient. FIG. 9 is a patient monitoring dashboard screen. FIG. 10 is a blood pressure screen for the patient.

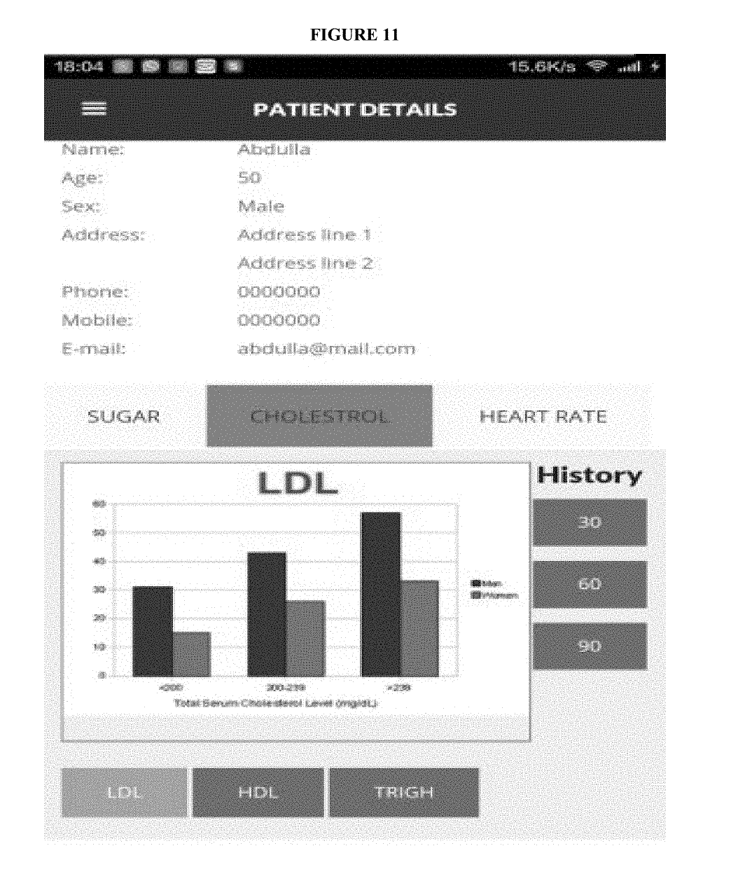

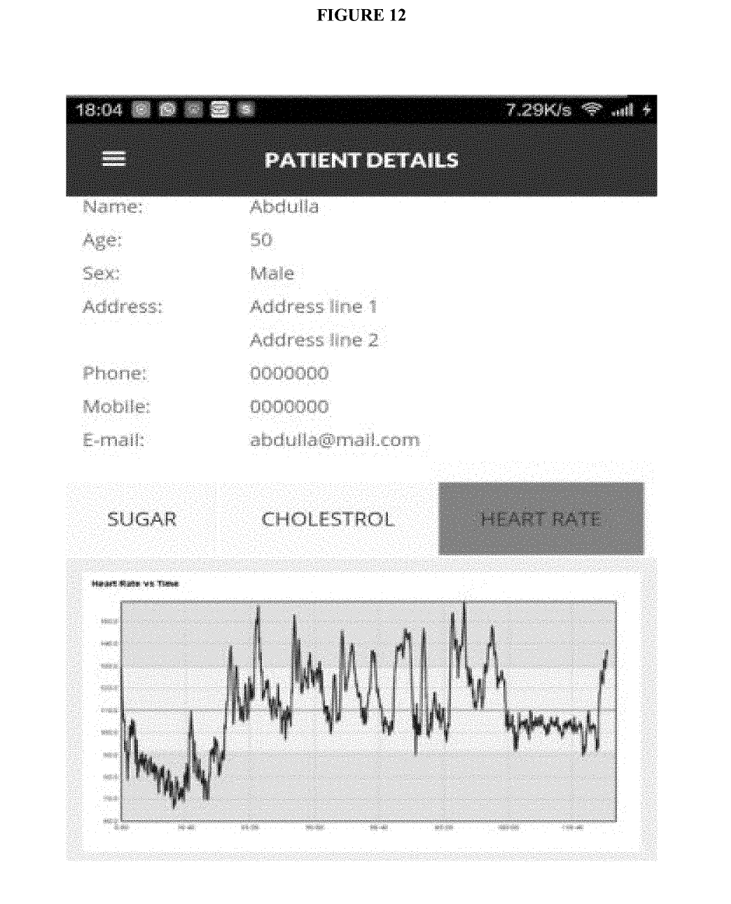

In an embodiment, the system uses the mobile devices as the target devices for visualization. FIGS. 10 to 12 are some sample screenshots of a mobile-based application used with the system. FIG. 10 is a physician view of the patient's profile details and blood sugar records. FIG. 11 is a physician view of the patient's profile details and cholesterol level records. FIG. 12 is a physician view of the patient's profile details and heart rate records.

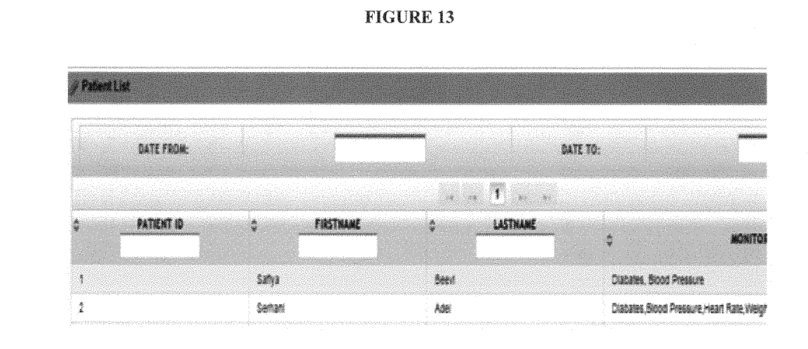

Additionally, in certain disclosed embodiments, one or more mobile devices may represent targets devices for any of the visualization processes described herein. These mobile devices may include, but are not limited to, smart phones, mobile computing devices, and tablet computers executing various mobile operating systems, such as Android and Apple iOS. FIGS. 13-23 illustrate additional images of graphical user interfaces generated in accordance with the disclosed embodiments and present (e.g., through corresponding display modules) on devices operated by patents and medical staff.

FIGS. 13-16 depict images of graphical user interfaces presented to medical staff by mobile or web applications executed on corresponding mobile devices (e.g., medical staff web application views). For example, FIG. 13 depicts a graphical user interface that presents a representation of a patient medical record to an attendant physician, which enables the attendant physician to monitor their health conditions in real-time and provide prompt medical assistant if necessary.

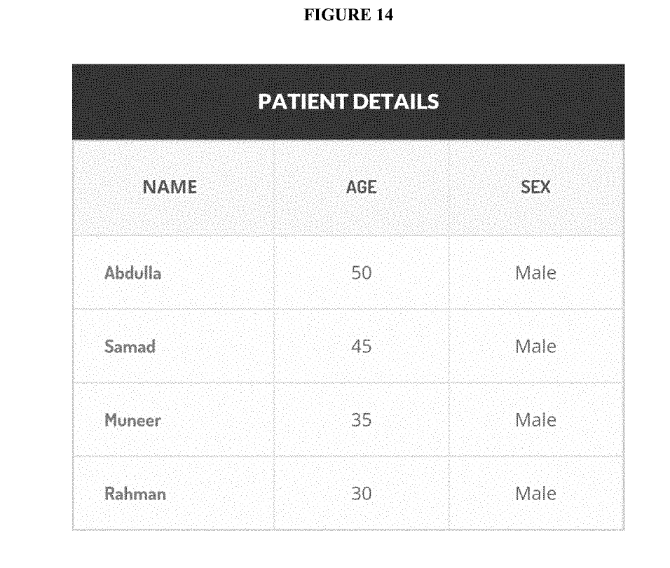

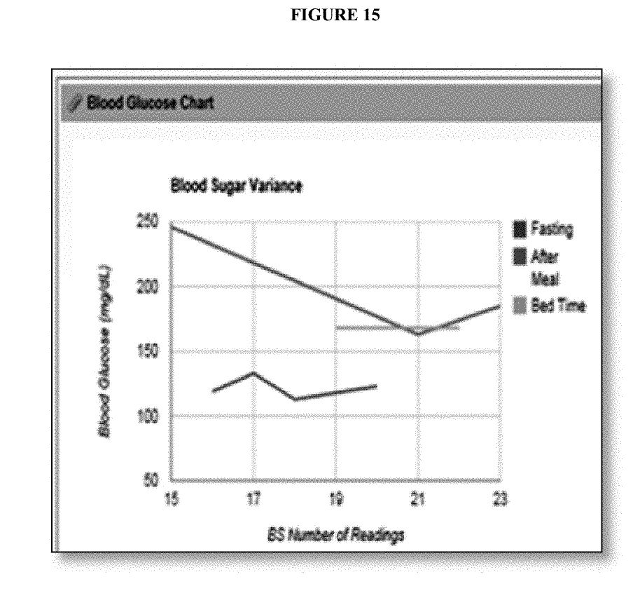

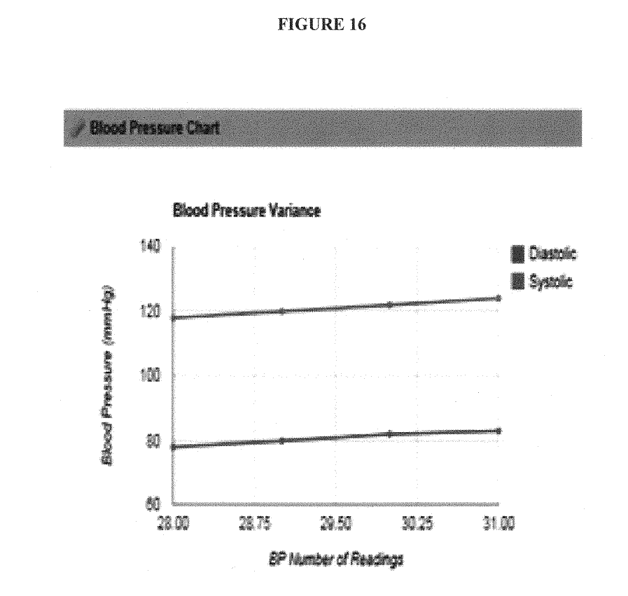

FIG. 14 depicts a graphical user interface that presents, to medical staff, a list of patients allocated to a specific physician based on the medical case. FIGS. 15 and 16 illustrate graphical user interfaces presenting an outcome of a simultaneous processing and analysis of collected sensor data to medical staff. For example, FIG. 15 depicts a presents a graphical user interface monitoring a patient's blood glucose level, and FIG. 16 presents a graphical user interface monitoring a patient's blood pressure level. In some aspects, the graphical user interfaces of FIGS. 15 and 16, and those monitoring other physiological parameters (not depicted), illustrate a time-evolution of the physiological parameters collected in real time, which may enable the medical staff to provide more accurate medical advice.

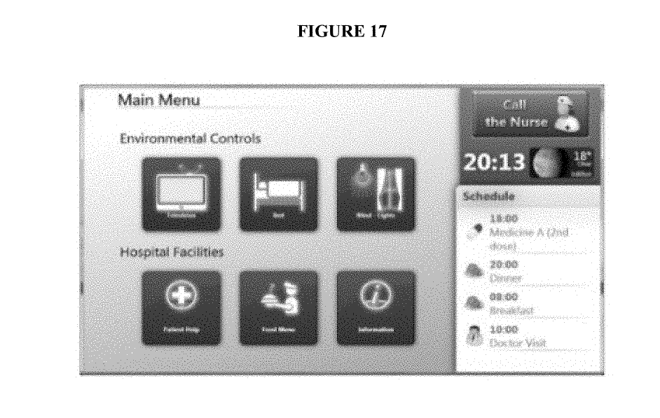

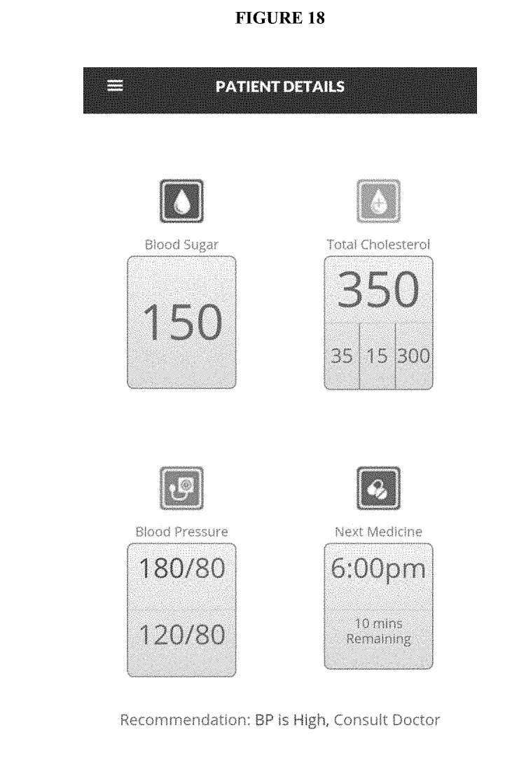

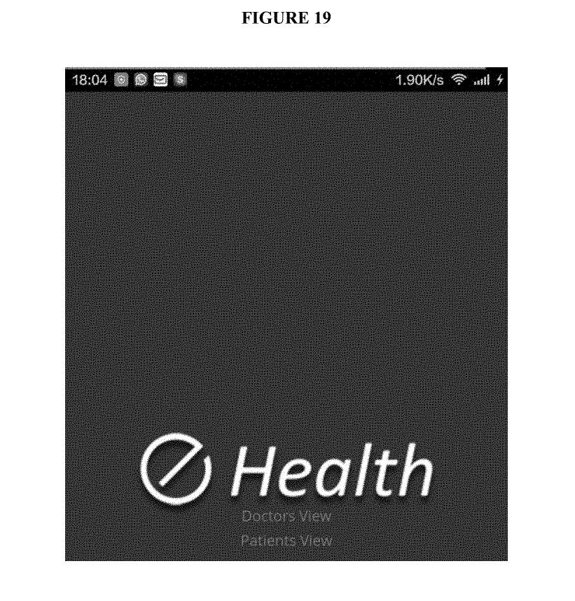

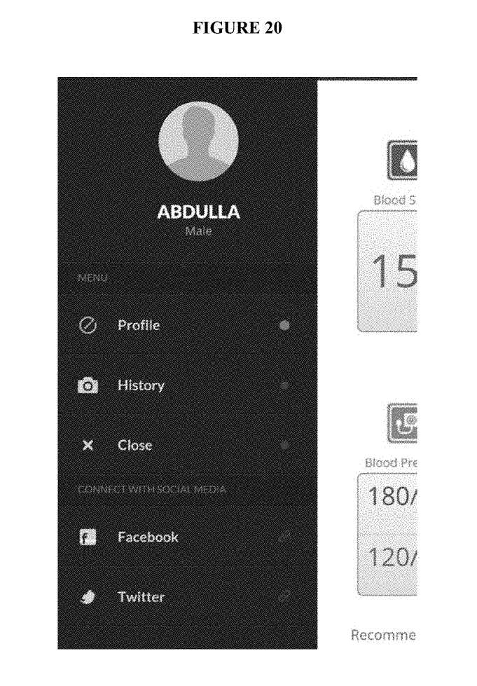

FIGS. 17-20 depict images of graphical user interfaces presented to a patient by mobile or web applications executed on corresponding mobile devices (e.g., patient mobile views). In some aspects, the presented graphical user interfaces may illustrate an outcome of the simultaneous processing and analysis of the collected sensor data, as described above. For example, FIG. 17 depicts a patient monitoring dashboard screen presents by a patient's mobile device through a corresponding graphical user interface. FIG. 18 illustrates a patient application view that, when presented to the patent through a corresponding graphical interface, displays simple and clear messages, such as health and nutrition advice, alerts on a current medical status (e.g., blood rate, and blood pressure, etc. FIG. 19 illustrates a presented homepage for the monitoring system having login options that include a physician view and a patient view, and FIG. 20 illustrates an example of the patent view, including a simplified representation of a user profile and other tools.

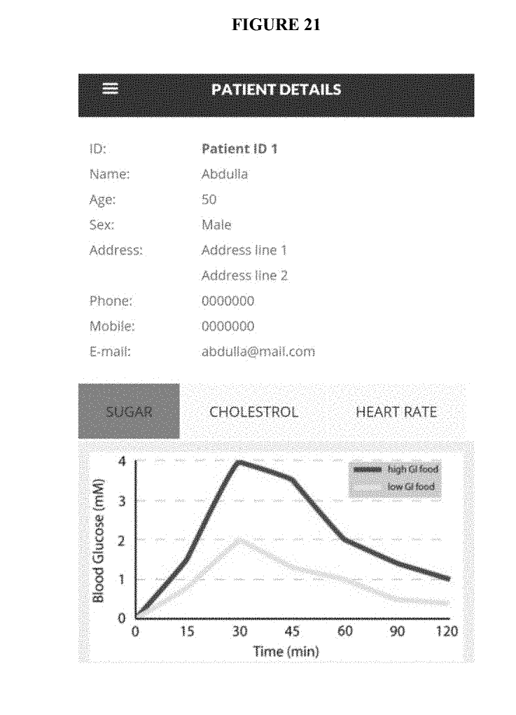

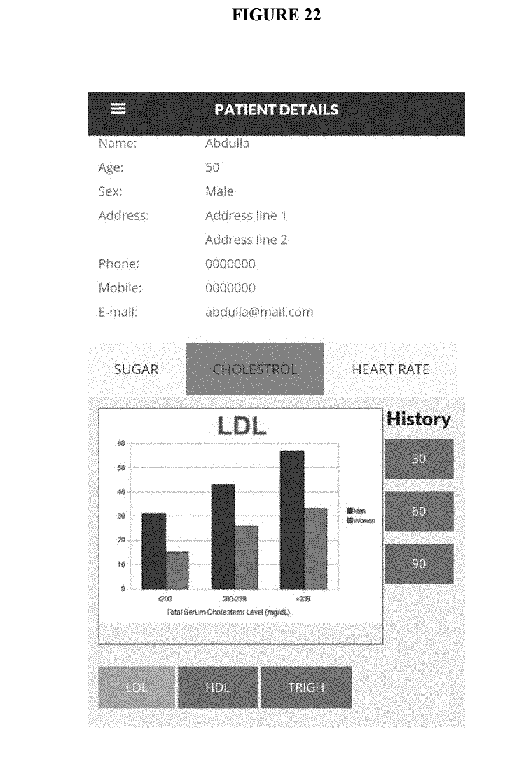

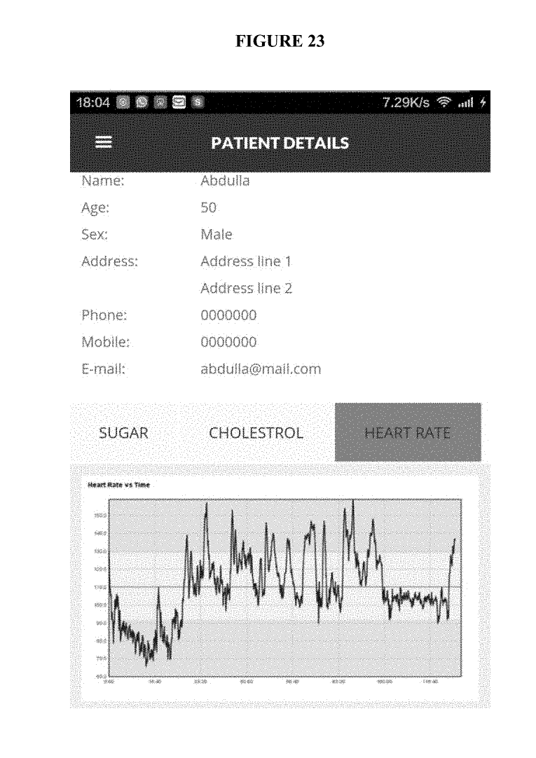

FIGS. 21-23 depict images of graphical user interfaces presented to a physician by mobile or web applications executed on corresponding mobile devices (e.g., physician mobile views). For example, FIG. 21 illustrates a graphical user interface presenting a patient's profile data and blood sugar records, FIG. 22 illustrates a graphical user interface presenting a patient's profile data and cholesterol level records, and FIG. 23 illustrates a graphical user interface presenting a patient's profile data and heart rate records.

For a considerable period of monitoring of 100 patients, the system was able to detect health deterioration with detection accuracy most of time close to 100%. By scaling the number of monitored patients with different diseases (blood pressure, cholesterol and blood sugar) the system remains stable and performs very well. No major performance issues or delay in communication and data transfer were recorded. Only slight performance deterioration was reported due to network bandwidth and sensor calibration. For vital signs of blood sugar, cholesterol level and heart rate the monitoring results are always accurate and reflect the real situation. For falling and motion monitoring, the monitoring results are mostly appropriate, however the accuracy in this situation is explained by the fact that some patients' movements might not be related to health deterioration, but to infrequent physical practices the patient is used to doing at home.

As the world population ages and the old-age support ratios diminish, innovative and smart healthcare administration is imperative. An important cornerstone of healthcare future administration is the adoption of remote health monitoring technologies. While significant research and development work is currently being undertaken, several barriers related to costs, industry standardization, regulatory frameworks, user acceptance, data privacy and security, among others are yet to be overcome. This monitoring system exploits various emerging technologies including biosensors, mobile technologies, and communication media to develop reliable, efficient and complete solution, which easily can scale with a number of users, sensors and homes. Thus, the system addresses several key barriers related to widespread adoption of remote health monitoring technologies.

In an embodiment, the disclosed system provides a smart healthcare solution that provides an end-to-end architecture that intelligently self-adapts in different contexts and reacts proactively to critical situations. The disclosed embodiments also provide a self-adaptive healthcare system that adapts to different patient environments, different disease types and different network conditions.

In other embodiments, the disclosed systems and processes perform operations that proactively address certain network conditions, and take actions to avoid any severe or resource shortage conditions. Such actions might include the following: (1) send only urgent information when the mobile network is loaded, (2) switch to standby mode and switch all activities when a patient is in an ideal condition.

The disclosed embodiments also provide and facilitate autonomous behaviour. The system described herein may implement a set of intelligent processes that are triggered to respond to different situations, analyses contextual parameters, executes a set of prescribed actions and collects new contextual information to be used for future similar situations.

The system may also enable physicians to support an aged community by providing advice, diagnoses and treatments. This will reduce the number of visits to hospitals, which will reduce the cost of elderly care and at the same time, reduce the burden on healthcare providers. In addition, the disclosed embodiments will allow access to advanced and specialized care to communities in remote locations with no access to specialized medical centers in the near vicinity. This will result in minimizing the duration of hospital stays or the need for intensive care at home.

The discloses systems and processes may provide a state-of-the-art platform to monitor health of the elderly and disable people around the clock in a smart-home environment seamlessly and non-intrusively. The system can address the problem of providing an expensive home-care visits or establishing a dedicated elderly centers by government authorities. A smart-home for healthcare monitoring is a cost-effective, environment friendly and sustainable system to take care of this important component of the society. Certain advantages of the disclosed system and processes are highlighted below.

The disclosed embodiments provide an integrated and customizable platform implemented using a set of sensors and actuators within the subject's home environment supporting medical data acquisition in a seamless and non-intrusive manner without disturbing the normal daily activities of the subjects.

The disclosed embodiments also provide healthcare professionals with access to the medical data acquired at home supporting the healthcare professionals to monitor the medical conditions of the subjects remotely.

Additionally, the disclosed systems and methods generate real-time alerts for healthcare professionals to enable timely and effective intervention depending on medical condition of the subject under monitoring.

The disclosed systems and processes also provide real-time advice related to the treatment and medication for the elderly depending on their health condition through suitable display devices.

The disclosed systems and processes may further provide real-time nutrition advice related to diet programs, sport practices, nutrition plans to enable preventive health management.

Further, the disclosed embodiments facilitate and enable time and cost efficient administration of healthcare services to elderly resident at home or old-age care centers.

Moreover, the disclosed systems and processes facilitate early discharge of non-vital cases to retain their normal life at home in a reliable and safe environment while enabling continued monitoring of health condition for the desirable lengthy time.

In certain disclosed embodiments, the systems and methods described herein provide health authorities with access to medical data of elderly suffering from chronic diseases for a long-term period which helps in data analytics and finding patterns regarding chronic diseases in the country and other statistics for health-related issues.

A differentiator of the system of the disclosed systems and processes also is the modular architecture with clearly defined interfaces between different modules and standardization of communication protocols, which enables scalability and interoperability.

II. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including the diagnostic module 5, the publishing module 6, the learning module 6.2, the intervention module 7, and others of the exemplary modules described above, can be implemented as one or more computer programs, i.e., one or more modules of computer program instructions encoded on a tangible non-transitory program carrier for execution by, or to control the operation of, data processing apparatus. Additionally or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” refers to data processing hardware and encompasses all kinds of apparatus, devices, and machines for processing data, including by way of example a programmable processor, a computer, or multiple processors or computers. The system can also be or further include special purpose logic circuitry, such as an FPGA (field programmable gate array) or an ASIC (application-specific integrated circuit). The system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification contains many specifics, these should not be construed as limitations on the scope of the application or of what may be claimed, but rather as descriptions of features specific to particular embodiments of the application. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

What is claimed is:

1. A system, comprising:
a storage device; and
at least one processor coupled to the storage device, the storage device storing software instructions for controlling the at least one processor when executed by the at least one processor, and the at least one processor is operative with the software instructions and is configured to:
receive values of physiological parameters indicating a current physiological status of a patient;
access a data repository comprising a plurality of diagnostic rules, the diagnostic rules linking conditions related to the physiological parameters to diagnostic information;
determine whether the received values satisfy the condition related to at least one of the diagnostic rules;
when the received values are determined to satisfy the at least one condition, generate advice data based on the diagnostic information linked to the condition by the at least one diagnostic rule, and to present the generated advice data to the patient through a corresponding interface;
determine whether the received values represent abnormal values;
when the received values are determined to represent the abnormal values, provide, to an intervention module, first output data comprising an indication that the received values are abnormal, the intervention module being configured to initiate an emergency action in response to the indication that the received values are abnormal; and
determine whether the received values fail to satisfy the conditions of the diagnostic rules;
when the received data fails to satisfy the conditions, provide, to the intervention module, second output data comprising an indication that the received values fail to satisfy the conditions of the diagnostic rules and information characterizing the current physiological status of the patient, the intervention module being configured to present data prompting the medical expert to provide advice to the patient based on the current physiological status of the patient.

2. The system of claim 1, wherein the at least one processor is further configured to detect when the patient falls, and to provide, to the intervention module, an indication that the patient has fallen, wherein the intervention module is configured to initiate the emergency action in response to the indication that the patient has fallen.

3. The system of claim 1, wherein the at least one processor is further configured to:
obtain health data of the patient from a computing system associated with at least one social network, the computing system being connected to the system across a communications network; and
generate a value for at least one physiological parameter based on the obtained health data.

4. The system of claim 1, wherein the at least one processor is further configured to determine that the received values represent the abnormal values based on the diagnostic information linked to the conditions by the at least one diagnostic rule.

5. The system of claim 1, wherein the at least one processor is further configured to determine that the received values represent the abnormal without referring to the at least one diagnostic rule.

6. The system of claim 1, further comprising an input module coupled to the at least one processor, the at least one processor being further configured to:
receive, through the input module, data indicative of the advice provided by the medical expert; and
generate an additional diagnostic rule linking an additional condition related to the current physiological status of the patient to the advice provided by the medical expert.

7. The system of claim 1, wherein the emergency action comprises at least one of:
transmitting warning data to a device of the medical expert, the warning data being indicative of the abnormal values, and the device of the medial expert being connected to the system across a combinations network; or
performing operations that trigger a request for dispatching an ambulance to a location associated with the patient.

8. The system of claim 1, further comprising a data acquisition module comprising a plurality of sensors, each sensor configured to acquire a value for at least one of the physiological parameters for the patient, wherein the at least one processor is further configured to receive the acquired values from the data acquisition module.

9. The system of claim 1, further comprising a display module coupled to the at least one processor, wherein the at least one processor is further configured to present the generated advice data to the patient through the interface via the display module.

10. The system of claim 9, wherein the intervention module is further configured to present, via the display module, data prompting the medical expert to initiate the emergency action.

11. The system of claim 9, wherein the intervention module is further configured to present, through the display module, the data prompting the medical expert to provide the advice to the patient.

12. The system of claim 1, wherein the storage device stores structured data records establishing the data repository.

13. A computer-implemented method, comprising:
receiving, by at least one processor, values of physiological parameters indicating a current physiological status of a patient;
accessing, by the at least one processor, a data repository comprising a plurality of diagnostic rules, the diagnostic rules linking conditions related to the physiological parameters to diagnostic information;
determining, by the at least one processor, whether the received values satisfy the condition related to at least one of the diagnostic rules;
when the received values are determined to satisfy the at least one condition, generating, by the at least one processor, advice data based on the diagnostic information linked to the condition by the at least one diagnostic rule, and presenting, by the at least one processor, the generated advice data to the patient through a corresponding interface;
determining, by the at least one processor, whether the received values represent abnormal values;
when the received values are determined to represent the abnormal values, providing, by the at least one processor, and to an intervention module, first output data comprising an indication that the received values are abnormal, the intervention module being configured to initiate an emergency action in response to the indication that the received values are abnormal; and
determining, by the at least one processor, whether the received values fail to satisfy the conditions of the diagnostic rules;
when the received data fails to satisfy the conditions, providing, by the at least one processor, and to the intervention module, second output data comprising an indication that the received values fail to satisfy the conditions of the diagnostic rules and information characterizing the current physiological status of the patient, the intervention module being configured to present data prompting the medical expert to provide advice to the patient based on the current physiological status of the patient.

14. A tangible, non-transitory, computer-readable medium storing instructions that, when executed by at least one processor, cause the at least one processor to perform a method, comprising the steps of:
receiving values of physiological parameters indicating a current physiological status of a patient;
accessing a data repository comprising a plurality of diagnostic rules, the diagnostic rules linking conditions related to the physiological parameters to diagnostic information;
determining whether the received values satisfy the condition related to at least one of the diagnostic rules;
when the received values are determined to satisfy the at least one condition, generating advice data based on the diagnostic information linked to the condition by the at least one diagnostic rule, and presenting the generated advice data to the patient through a corresponding interface;
determining whether the received values represent abnormal values;
when the received values are determined to represent the abnormal values, providing, to an intervention module, first output data comprising an indication that the received values are abnormal, the intervention module being configured to initiate an emergency action in response to the indication that the received values are abnormal; and
determining whether the received values fail to satisfy the conditions of the diagnostic rules;
when the received data fails to satisfy the conditions, providing, to the intervention module, second output data comprising an indication that the received values fail to satisfy the conditions of the diagnostic rules and information characterizing the current physiological status of the patient, the intervention module being configured to present data prompting the medical expert to provide advice to the patient based on the current physiological status of the patient.
